(19) United States
(12) Patent Application Publication
(10) Pub. No.: US 2020/0128823 A1
(43) Pub. Date: Apr. 30, 2020

(54) ALGICIDAL, ALGISTATIC, HERBICIDAL AND HERBISTATIC TREATMENT OF WATER

(71) Applicant: BioCap Tech, Nilvange (FR)

(72) Inventors: Jean-Claude PIHAN, Metz (FR); Loïc CHOMEL DE VARAGNES, Metz (FR)

(73) Assignee: BioCap Tech, Nilvange (FR)

(21) Appl. No.: 16/494,078

(22) PCT Filed: Mar. 12, 2018
(86) PCT No.: PCT/EP2018/056084

§ 371 Date: Sep. 13, 2019

(30) Foreign Application Priority Data
Mar. 15, 2017 (FR) 1752102

(51) Int. Cl. A01N 37/40

(52) U.S. Cl. CPC A01N 37/40

(57) ABSTRACT

A use of a composition comprising gallic acid as an active ingredient for an algicidal, algistatic, herbicidal or herbistatic treatment of an aquatic bottom stratum of water by the controlled release of the active ingredient. The invention also concerns the processes for manufacturing this composition. Another object concerns a method for treating an aquatic bottom stratum.

### TECHNICAL FIELD

The present invention concerns the field of the algicidal and herbicidal compositions, the processes of manufacturing as well as the methods of treatment associated with aquatic bottom strata.

### STATE OF THE ART

Algae are common and colonize water that is more or less stagnant, and exposed to light. Their proliferation is thus favored by the stagnation of water, the high concentration of nutrients, the decomposition of organic matter within the environment and the reduction of micropollutants. Algae can be divided according to their size into phytoplanktonic microalgae distributed in the body of water and into macroalgae with, according to the space they occupy in the water: floating algae resting on the surface, and submerged algae attached to the sediments and referred to as benthic algae. According to the conditions (current, life cycle), benthic algae can be detached from the bottom and become floating. Benthic algae grow in freshwater as well as in oceans or seas. Benthic algae are categorized into several large groups or classes according to the color and the nature of their pigments: Cyanobacteria commonly called blue algae (the new classification creates them an own membership apart from the algae), Chlorophytes or green algae including filamentous species subdivided into Chlorophyceae and Zygophyceae, Chromophytes or brown to yellow algae subdivided into Xanthophyceae or yellow algae and Pheophyceae or brown algae, Diatomophyceae (Bacillariophyceae with a siliceous skeleton) and Chrysophyceae or golden algae, Pyrrophytes or also brown algae subdivided into Cryptophyceae and Dinophyceae, Rhodophytes or (marine) red algae finally Euglenophytes making the transition between the plant world and the animal world depending on the presence or absence of Chloroplasts. Cyanophyceae include unicellular species or colonies of phytoplankton and benthic species associations forming crusts on the bottom, which can peel off and colonize the surface by forming floating materials. Characeae previously classified in green algae (Chlorophyceae) are now considered as a distinct group making the transition between algae and hydrophytes.

Bryophytes and Pteridophytes (Aquatic mosses and ferns) have invasions in some specific environments.

Hydrophytes, also known as aquatic macrophytes, are plant types that live partly or totally immersed in water for much of the year or even all year round. The different biological types are defined in accordance with their position relative to the water surface, the free hydrophytes, floating materials which float on the surface (pleustophytes) and the attached hydrophytes which are rooted in the ground are in particular distinguished within this class. The latter are subdivided into plants with floating leaves (up to 3 m of water) (water lily) and fully immersed plants (waterweed) and which, when reaching the surface, form a dense canopy in the surface stratum of water. The introduction of some exotic species, in particular Canadian Waterweed, into the waters has created some problems because of their uncontrollable proliferation; they are referred to as (proliferating) invasive exotic species and they have a negative impact on autochthonous biodiversity. Some indigenous (autochthonous) species may also have excessive proliferations with, identically, a decline in the diversity and the loss of some water uses. Moreover, the littoral zone has a belt of amphibious plants called “Helophytes” (reeds, cattails, rushes, Sedges). Definition: “invasive exotic species”: an exotic species whose introduction or spread had proved to be a threat to the biodiversity and the associated ecosystem services, or to have adverse effects on the biodiversity and said services.

Algal proliferations, called water blooms, efflorescences, algal blooms, green, blue or red tides, as well as the invasion of the aquatic environments by bryophytes, pteridophytes and macrophyte meadows have multiple impacts on the different uses of water and on the ecosystem. In particular, the effects on drinking water consumption may be mentioned. During cyanobacterial proliferations, water becomes particularly unpleasant to taste, to smell and in appearance. The production of phycotoxins most often causes food poisoning (hepatotoxins), but also respiratory, nerve (neurotoxins) and skin (dermatotoxins) diseases. Therefore, there is an impact on public health and the economy due to the rising cost of the water treatment. Algal or macrophyte proliferations also affect industrial activities, fishing and aquaculture production, and cause the obstruction of waterways and the hooking of fishermen's hooks in macrophytes and filamentous chlorophytes.

The proliferations of algae, bryophytes, pteridophytes and macrophytes which are one of the consequences of water eutrophication, leads to the production of biomass with the destruction of many biotopes. There is a significant reduction in the transparency of the water, therefore in the efficiency of the photosynthetic radiation which causes the decrease of the phytoplankton and jointly zooplankton diversity. This leads to a multiplication of decomposing microorganisms and causes a pronounced deficiency of oxygenation by excessive consumption of oxygen with a risk of suffocation for fish, which leads to enrichment in organic matter of the sediment after decantation of the dead plants then a total anoxia of the bottom, because the exacerbated bacterial degradation activity is oxygen consuming. The salting-out, due to the anoxia of the aquatic environment, of nutrients by the sediments also favors the hyper-eutrophication of the aquatic environment. The efflorescences and crusts of cyanobacteria produce a stench-like foam and release, for example, geosmin, giving the flesh of fish a bad taste of mud. The overabundance of aquatic vegetation in the summer period leads to an uniformization of the facies and constitutes an obstacle to the flow, a source of inadvertent overflow of the river. In general, the phenomena of algal or aquatic macrophyte proliferations cause the aesthetic deterioration of water bodies and other aquatic environments.

In order to combat the proliferations of algae, bryophytes, pteridophytes or macrophytes, several treatments have already been considered. These treatments mainly implement substances produced by synthetic chemistry. The chemical algicides or herbicides that have been used or are still used in some countries in aquatic environment are mainly based on copper and its derivatives, chlorine and its derivatives, hydrogen peroxide, bromine, amines, phytosanitary products, plant hormone inhibitors. The European Directives on pesticides (Biocides and Phytosanitary; Biocides Regulation No. 528-2012) restrict or prohibit the use of many harmful substances for humans, animals and the entire ecosystem, for example in aquatic environment the use of copper and its derivatives, TBT (tributyltin), Diquat, Dichlobenil, Fluridone, Roundup and Monolinuron.

In addition, these chemical treatments have been limited to algae treatments that develop in artificial environments (chlorine in swimming pools) and few natural sites were the subject of an application considering the volume of water to be treated and the consequences of the use of synthetic chemical biocides on the entire ecosystem. No natural algicides or herbicides are currently used in aquatic environment.

Patent FR 2 979 188 discloses an algicidal, algistatic, herbicidal or herbistatic composition. The composition comprises an absorbent or encapsulating polymer and one or more polyphenol(s). The invention also concerns the use of this composition as an algicidal, algistatic, herbicidal or herbistatic composition. The invention also relates to the processes for manufacturing this composition as well as to a device comprising a closed and filtering container containing said algicidal, algistatic, herbicidal or herbistatic composition, preferably in the form of microbeads, beads, granules, particles, cubes, cylinders, gel or gel fragments. An object of the present invention also concerns a method of an algicidal, algistatic, herbicidal or herbistatic treatment implementing this composition or the device comprising said composition. Patent applications CN 104 860 383 A and CN 104 891 619 A disclose algicidal compositions in the form of hydrogel spheres comprising gallic acid allowing controlling algal blooms. Patent application JPH 9151102 discloses an antibiotic composition of gallic acid comprising an excipient or an emulsifier to control algae found in rice fields or lakes. Patent CN 104 671 367 B discloses an algicidal composition treating the algal efflorescence occurring at the surface of aquatic environments comprising an allelochemical substance chosen from gallic acid, nonoic acid or N-phenyl-naphthylamine as well as chitosan and the autoclaved brick powder of fly ash. The article by Hu and al., entitled “Algal-bloom control by allelopathy of aquatic macrophytes—A review” in Front. Environ. Sci. Engin. China 2008, 2(4): 421-438 describes the use of allelopathic compounds originating from macrophytes in order to control algal bloom. The article by Nakai and al., entitled “Algal growth inhibition effects and inducement modes by plant-producing phenols” in Wat. Res. Vol. 35, No. 7, pp. 1855-1859, 2001, describes the inhibitory effect of phenols derived from plants. The article by Guo and al., entitled “Effects of chitosan, gallic acid, and algicide on the physiological and biochemical properties of Microcystis flos-aquae” in Environmental Science and Pollution Research (2015), 22(17), 13515-13521 describes the algicidal effect of gallic acid combined with chitosan. The article by Usenko and al. entitled “Algicide properties of polyphenols depending on molecular structure” in Gidrobiologicheskii Zhurnal (2004), 40(4), 97-105 describes the relationship between the structure of polyphenols and their influence on cyanobacteria and algae. The article by Uddin and al., entitled “Herbicidal activity of phenolic compounds from hairy root cultures of Fagopyrum tataricum Gaertn.” In Weed Research, 2012 describes allelopathic compounds derived from a plant Fagopyrum tataricum as well as their phytotoxicity. International application WO 03/073856 A1 describes the use of a herbicide comprising at least one metal compound such as Fe²⁺ or Fe³⁺ ions and at least one chelating agent.

Thus, in view of these elements, there is a real need to develop a method and/or a product capable of controlling the proliferation of algae, bryophytes, pteridophytes and rooted aquatic macrophytes, whose action is targeted and limited to the aquatic bottoms. In addition, said method or product should ideally be adapted to all aquatic environments, while protecting all non-target organisms of the aquatic ecosystem to be treated.

### OBJECT OF THE INVENTION

An object of the present invention is therefore to propose a solution to treat, on the one hand, in bottom stratum, attached benthic algae, bryophytes, pteridophytes and rooted aquatic macrophytes; the treatment must not significantly affect the non-target organisms of the aquatic ecosystem to be treated.

### GENERAL DESCRIPTION OF THE INVENTION

In order to solve the aforementioned problem, the present invention proposes, in a first aspect, a use of a composition comprising gallic acid as an active ingredient wherein gallic acid is associated with one or more excipient(s) selected from the following groups:

(1) a binder product such as wheat flour, soluble starch or rosin,

(2) a gelling product such as agar-agar, alginates, carrageenan, pectin, chitosan, cellulose or gelatin,

(3) a thickening product such as gum arabic, guar gum or xanthan gum,

(4) a swelling and disintegrating product such as bentonite or smectite, and

(5) an effervescent product such as bicarbonates,

wherein gallic acid is in encapsulated or compacted form, and

wherein the content of excipient(s) is comprised between 50% and 5% of the total weight of the composition,

for an algicidal or algistatic treatment of akinetes at an aquatic bottom stratum of water by the controlled release of the active ingredient.

In a second aspect, the invention concerns a composition having an algicidal or algistatic effect on akinetes at an aquatic bottom stratum of water, the composition comprising, as an active ingredient, gallic acid associated with one or more excipient(s) selected from the following groups:

(1) a binder product such as wheat flour, soluble starch or rosin,

(2) a gelling product such as agar-agar, alginates, carrageenan, pectin, chitosan, cellulose or gelatin,

(3) a thickening product such as gum arabic, guar gum or xanthan gum,

(4) a swelling and disintegrating product such as bentonite or smectite, and

(5) an effervescent product such as bicarbonates,

wherein gallic acid is in encapsulated or compacted form,

wherein the content of excipient(s) is comprised between 50% and 5% of the total weight of the composition,

and whose density is greater than 1 kg/dm³, preferably greater than 1.05 kg/dm³ and more preferably greater than 1.1 kg/dm³.

A third aspect of the invention concerns a process for manufacturing such compositions having an algicidal or algistatic effect.

Finally, according to a fourth aspect, the invention also proposes a method of algicidal or algistatic treatment of an aquatic bottom stratum using a composition as described in this document for the controlled release in an aquatic bottom stratum of water.

A first advantage of the invention is that gallic acid is not a synthetic chemical. The European directives including the European Regulation BIOCIDE 528-2012 are very strict and restrict or prohibit the use, in natural environment, of synthetic chemicals.

Gallic acid by transforming into gallates acts by combining two modes of action: gallic acid having entered the cell causes, by forming gallates, deficiencies in micronutrients which are essential for the plant metabolism of the targeted plant (depletion of iron); the gallates in the water outside the organism prevent photosynthesis from occurring by coloring the water of the environment to be treated with a high absorbance of wavelengths effective therefor.

The manufacture of balls, granules, capsules, as described in more detail below, allows salting-out kinetics of the active substance ranging from a few days to a few weeks and allows a targeted effect on the aquatic bottom.

Surprisingly, the inventors have been able to show that the majority of organisms are targeted by treating only a restricted volume of bottom water.

This approach is innovative in limiting the volume of water to be treated, reducing the amount of active substance to be used and in respecting non-target organisms.

In the context of the present invention, the following terms are defined as follows. The term “algicidal” refers to any product or substance which has the property of destroying algae. The term “algistatic” refers to any product or substance which has the property of preventing the growth of algal species. The term “herbicide” refers to any product or substance which has the property of destroying bryophytes, pteridophytes, and aquatic macrophytes (hydrophytes). The term “herbistatic” refers to any product or substance that has the property of preventing the growth of rooted aquatic macrophytes. The term “aquatic bottom stratum of water” refers to the space between the floor of any aquatic environment and whose height is at most 30 cm. The term “controlled release” refers to the release of active substance(s) at the desired location while controlling the release rate thereof. This rate is such that, according to their conditioning, the release is done over a few days to a few weeks.

In more detail, the compositions according to the invention comprise, as active principle, gallic acid. Optionally, the composition comprising gallic acid is further associated with at least one phenolic acid or polyphenol selected from the group consisting of pyrogallic acid, ellagic acid, tannic acid, gallotanic acid, caffeic acid, quercetin, resveratrol, resorcinol, catechol and scopoletin or among the alkaloids, gramine and hordenine.

One of the advantages of using gallic acid, as well as possibly phenolic acid(s), polyphenol(s) or alkaloid(s) as algicidal, algistatic, herbicide or herbistatic substance(s) is that they are molecules of natural origin. Indeed, these molecules are secondary metabolites which are produced by plants for the purpose of influencing their biological activities (intraspecific interactions) or for acting on their environment (interspecific interactions). The present invention therefore implements the concept of allelopathy. Allelopathy is the set of several direct or indirect positive or negative biochemical interactions from one plant to another by means of secondary metabolites such as, among others, phenols, polyphenols and alkaloids. The interference from one plant to another is attributed mainly to competitive effects for environmental resources such as water, light, nutrient compounds. Secondary metabolites, such as phenols, polyphenols and alkaloids, can have different effects on the environment of a plant. For example, some secondary metabolites allow inhibiting the germination and the growth of the plants growing in their vicinity while others have herbicidal properties. The secondary metabolites implement different modes of action such as the inhibition of photosynthesis of target plants, the inhibition of the electron transport or the disturbance of the mineral absorption by the plant. Not all plant species are sensitive to the same secondary metabolites.

One of the advantages of the present invention is that the use of gallic acid as an algicidal, algistatic, herbicidal or herbistatic substance allows a precise and targeted action of the aquatic macrophyte, algae, bryophyte or pteridophyte to be treated. In other words, unlike the known algicidal, algistatic, herbicidal or herbistatic substances which have a very broad spectrum of action and are derived from synthetic chemistry, the use of gallic acid allows a more specific action on aquatic macrophytes, algae, bryophytes or pteridophytes to be treated. In addition, unlike algicidal, algistatic, herbicidal or herbistatic substances of chemical origin, gallic acid has the advantage, by its biodegradability, of not accumulating in the environment and, by its non-bioaccumulation, of not being concentrated (biomagnification) in the food chain and therefore of not contaminating the non-target organisms of the ecosystem of the aquatic environment treated, as well as of not compromising its natural balance. The fauna and flora, with the exception of aquatic macrophytes, algae, bryophytes or targeted pteridophytes, are therefore not affected by the composition according to the present invention. This algicidal, algistatic, herbicidal or herbistatic composition is therefore part of sustainable development. Use is made of “Biomimetism” that is to say, the choice of natural biodegradable substances having an allelopathic action enhanced by their conditioning and the protocol of their use.

Gallic acid or 3,4,5-trihydroxybenzoic acid (Structure 1) is an aromatic organic compound, widely distributed in plants either in free form or as a component of gallotannins. It is part of the acid-phenols (phenolic acids) since it simultaneously includes phenolic hydroxyls and a carboxylic function. It is also a derivative of benzoic acid. Salts and acids derived therefrom are called gallates. It can be found in the natural state and at notable concentrations in galls of oaks (gall nuts), sumac, hamamelis, tea leaves, oak bark, among other plants.

Due to the presence of phenolic hydroxyl functions and a carboxylic function, gallic acid has antioxidant and prooxidant properties. Some conditions, including the concentration, change the prooxidant activity into an antioxidant activity. Up to 280 mg/L (threshold pH 6.8) and at pHs generally found in aquatic environments, gallic acid is a prooxidant with an oxidative stress in the plant, as a consequence. This oxidative stress is manifested by an acceleration of the oxidation of deoxyribose induced by OH hydroxyl radicals produced by Fe³⁺—H₂O₂. The cytotoxic activity would be explained by the production of reactive derivatives of oxygen (DRO); DROs are chemical species capable of oxidizing proteins, DNA and the cell membranes by lipid peroxidation. Gallic acid also causes a strong growth of O₂-mitochondrial superoxide radicals.

Above 280 mg/L, gallic acid is an antioxidant. In addition, it is a reactive molecule since it can form, by chelation, complexes with metals such as iron or lead.

One of the properties of gallic acid is the formation of gallates by chelation; most often gallates of iron. With iron (III) chloride (ferric chloride, FeCl₃), it produces the blue-black iron gallate referred to as Prussian blue. Gallates are also formed by complexing with other metals such as Cr³⁺ and Fe²⁺. At first, gallic acid reacts with iron II producing a water-soluble gallate of iron II, then the oxidation thereof produces an insoluble gallate of iron III. If necessary or desired, the compositions of the invention may comprise in addition to iron II or

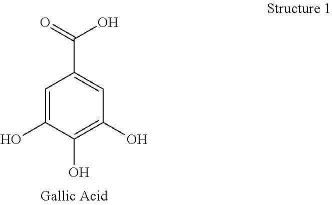 [SMILES: O=C(O)c1cc(O)c(O)c(O)c1]

Physicochemical Properties of Non-Hydrated Gallic Acid:

Formula: C₆H₂(OH)₃COOH

Physical state: solid, white crystals

Molar mass: 170.1195±0.0075 g·mol⁻¹

Melting temperature: 210° C.

Solubility: 11.9 g·L⁻¹ (water at 20° C.)

Density: 1.694 g·cm⁻³ at 6° C.

Physicochemical Properties of Gallic Acid Monohydrate:

Formula: (C₆H₂(OH)₃COOH.H₂O)

Physical state: solid, white crystals

Molar mass: 188.14 g·mol⁻¹

Solubility: 15 g·L⁻¹ (water at 20° C.) with an interest for the dissolution in natural environment compared to non-hydrated gallic acid.

In general, the gallic acid content is comprised between 50% and 95% of the total weight of the composition, preferably between 70% and 90% of the total weight of the composition, and more preferably between 75% and 85% of the total weight of the composition.

Previous experiments have shown that a composition composed only of gallic acid or optionally associated with at least one phenolic acid or polyphenol or alkaloid does not dissolve or is very difficult to dissolve in water. In order to avoid this problem, excipients of different nature but without algicidal, algistatic, herbicidal or herbistatic effect are preferably added. The excipients are desirable to allow a rapid descent on the bottom of the various conditioning, the dissolution of the active substance or optionally of the active substances and secondly to create a stratum of a density greater than that of the water by a thickening action.

According to one embodiment, the composition is associated with one or more excipient(s) selected from a binder product, a gelling product, a thickening product, a swelling and disintegrating product, an effervescent product.

The term “binding product” refers to a product which is used to agglomerate into a solid mass, solid particles in the form of powder or granules. Soluble starch or rosin, etc. may be mentioned.

The term “gelling product” refers to a product allowing giving a substance the consistency of a gel. It may be extracts of animal bones or plant extracts. Agar agar, alginates, carrageenan, pectin, chitosan, cellulose, gelatin, etc. may be mentioned.

The term “thickening product” refers to a product allowing a substance to have a certain consistency. Gum arabic, guar gum, xanthan gum, etc. may be mentioned.

The term “swelling and disintegrating product” refers to a product allowing the swelling in an aqueous medium, as well as the satisfactory disintegration. Bentonite, smectite, etc. may be mentioned.

The term “effervescent product” refers to a product capable of dissolving rapidly in water or any other liquid by releasing carbon dioxide. This release induces the effervescence and the fragmentation of the product. In particular, bicarbonates may be mentioned.

In addition, gallic acid optionally associated with at least one phenolic acid, polyphenol or alkaloid previously mentioned can be used with all types of described excipients. Preferably, the excipients are chosen from two excipients belonging to two distinct groups, and preferably the excipients are chosen from binder products and thickening products.

In general, the content of excipient(s) is comprised between 50% and 5% of the total weight of the composition, preferably between 30% and 10% of the total weight of the composition, and more preferably between 25% and 15% of the total weight of the composition.

In a preferred variant, the composition has a density greater than 1 kg/dm³, preferably greater than 1.05 kg/dm³ and more preferably greater than 1.1 kg/dm³. Indeed, according to the invention, the composition must target the bottom of the aquatic environment to be treated before the release of the active substance. For this purpose, its density must be greater than that of the water of the environment to be treated so that the composition flows rapidly to the bottom of the water, preferably with a sufficient speed to avoid a significant dissolution of the active ingredient(s) before reaching the bottom of the water. In practice, the density (and, if necessary, the size) of the composition is preferably chosen so as to obtain sedimentation rates greater than 1·10⁻⁴ m/s, more preferably greater than 1·10⁻³ m/s, in particular greater than 0.01 m/s, or even greater than 0.1 m/s.

Another appreciable advantage of the present invention is that the excipient constitutes a carrier for the active substance thus allowing an easy use of the composition. The composition may be in various forms and volumes, according to the nature of the excipient, and in particular in the form of granules, balls or capsules of average mass between 1 and 100 g, preferably between 2 and 50 g, more preferably between 10 and 30 g for the balls and between 2 and 5 g for the granules and the capsules. In general, the composition preferably takes the encapsulated or compacted form of an object associated with one or more aforementioned excipient(s), of predetermined dimensions, which offers easy packaging, handling and transport possibilities. It will also be understood that the nature of the excipient determines the salting-out kinetics of the phenolic acid(s), polyphenol(s) or alkaloid(s) in the aquatic environment(s).

The composition according to the invention therefore constitutes an algicidal, algistatic, herbicidal or herbistatic product applying the principle of allelopathy and allowing an implementation on the ground as close as possible to the targeted plant biomass, aquatic algae, bryophytes, pteridophytes or macrophytes.

Algicidal, algistatic, herbicidal or herbistatic composition may be used to treat any aquatic environment likely to comprise attached/rooted aquatic algae, bryophytes, pteridophytes and/or macrophytes. The aquatic bottom stratum of water which is targeted by the composition preferably having a height of at most 30 cm, more preferably at most 20 cm, in particular at most 15 cm.

These aquatic environments may comprise freshwater, brackish water or salt water (sea or ocean water). Preferably, these are aquatic environments comprising freshwater. They may be enclosed aquatic environments such as the pools, the ponds, the reservoirs, impoundments, lagoons, sand pits, lakes, parks and intensive aquaculture production enclosures (crustaceans, fish), swimming pools and aquariums. The free aquatic environments such as for example river and canal reaches could also be considered, in particular during a severe low-flow period.

The types of aquatic algae, bryophytes, pteridophytes and macrophytes that can be treated by the composition according to the present invention are attached or rooted. In particular, the algae may be Cyanobacteria commonly called blue algae (the new classification creates them a proper membership apart from algae), Chlorophytes or green algae including filamentous species subdivided into Chlorophyceae and Zygophyceae; Chromophytes or brown to yellow algae subdivided into Xanthophyceae or yellow algae and Pheophyceae or brown algae; Diatomophyceae (Bacillariophyceae with a siliceous skeleton) and Chrysophyceae or golden algae; Pyrrhophytes or also brown algae subdivided into Cryptophyceae and Dinophyceae (Peridinians, Dinoflagellates); Rhodophytes or (marine) red algae finally Euglenophytes. Dinophyceae (Peridinians, Dinoflagellates) can form red tides with the contamination of the marine production (ciguatera of shells and fish) presenting a risk to human health.

Among the algal species attached or trapped in aquatic macrophytes, concerned by an invasive proliferation, mention may be made of

Encrusting filamentous benthic cyanobacteria such as: Lyngbia sp., Oscillatoria sp., Phormidium sp., Stigonema.

The forms of resistance of cyanobacteria of phytoplankton deposited on the sediment, in particular to survive the winter. These forms, referred to as “Akinetes”, are the cause of the blooms from spring to autumn. Akinetes are dormant cells with thick walls derived from the growth of a vegetative cell. It is found not only in cyanobacteria, but also in unicellular and filamentous green algae.

Diatomophyceae forming benthic colonies such as: Melosira sp, Gomphonema sp including some invasive species.

Filamentous or frond Macroalgae such as:

Characeae such as Chara sp.; Nitella sp.

Chlorophytes such as: among Zygophyceae, Mougeotia sp.; among Chlorophyceae, Microspora sp., Ulothrix sp., Ulva sp., Cladophora sp., Rhizoclonium sp., Oedogonium sp., Spirogyra sp., Zygnema sp., Caulerpa sp., Hydrodictyon. sp.

Chromophytes Pheophyceae such as: Sargassum sp.

Chromophytes Xanthophyceae such as: Vaucheria sp., Tribonema sp.

Concerning aquatic Bryophytes and Pteridophytes likely to proliferate, mention may be made of:

Among bryophytes: Fontinalis sp., Cinclidotus sp.

Among pteridophytes: Azolla sp., Salvinia sp.

Concerning invasive aquatic macrophytes (plants likely to proliferate in France with an impact on the different uses of water) creating eradication problems for the managers of the freshwater aquatic environments, it may be mentioned among the main kinds:

Indigenous pondweeds: Stuckenia pectinata (sago pondweed); Potamogeton lucens (shiny pondweed); P. Crispus; P. Fluitans; P. Natans; P. gramineus, P. perfoliatus.

Watermilfoils: Myriophyllum spicatum (indigenous Eurasian watermilfoil), Myriophyllum verticillatum (indigenous, whorled watermilfoil) Myriophyllum aquaticum (aquatic watermilfoil introduced from Brazil),

Hornworts: Ceratophyllum demersum (indigenous rigid hornwort or coontail). Ceratophyllum submersum (soft hornwort).

Waterweeds (introduced): Elodea nuttallii (Nuttall's waterweed, origin North America/North American in origin); E. canadensis (Canadian waterweed); E. ernstiae (origin, Argentina). Lagarosiphon major (curly waterweed, origin—South Africa); Elodea densa or Egeria densa (large-flowered waterweed known also as Brazilian waterweed, origin South and Central America).

Ranunculaceae (indigenous): Ranunculus aquatilis (water-crowfoot also known as Amazon frogbit); R. pennicillatus and R. peltatus.

Trapaceae (indigenous): the fruits and rhizomes of the water chestnut (Trapa natans).

Other introduced amphibious riparian macrophytes: Primrose willow (South America): Ludwigia peploids (creeping primrose willow), L. grandiflora (large-flowered primrose willow) and L. Uruguayensis; Impatiens glandulifera (Himalayan balsam or impatient).

The algicidal, algistatic, herbicidal or herbistatic effect of gallic acid results in a double action, on the one hand, an intracellular action. Gallic acid that enters a cell develops its chelating property; by complexing with intracellular iron, gallic acid blocks the metabolism of the cells by depletion thereof. Iron acting as a coenzyme for many metabolic reactions in vacuoles, chloroplasts and nuclei, this is followed by the cell death. On the other hand, the formation of gallates of iron in water causes the blue-black coloration called Prussian blue of the stratum of water, which forms a shield against light rays and prevents photosynthesis from occurring.

The concentration of gallic acid in the aquatic bottom stratum of water is generally controlled to values ranging from 0.05 mg/L to 500 mg/L, in particular to chronic toxic concentrations, such as concentrations ranging from 0.1 mg/L to 10 mg/L, preferably ranging from 0.2 mg/L to 5 mg/L, or in particular to acute toxic concentrations, such as concentrations ranging from 60 mg/L to 500 mg/L, the aquatic bottom stratum of water preferably having a height of at most 30 cm, more preferably at most 20 cm, in particular at most 15 cm.

The term “acute toxicity” refers to a treatment from the composition administered at concentrations above 60 mg/L over a short duration, of a few days.

The term “chronic toxicity” refers to a treatment from the composition administered at concentrations below 10 mg/L over a long duration, of a few weeks.

According to another variant, at least one portion of the algicidal, algistatic, herbicidal or herbistatic effect is obtained by a coloration in an aquatic bottom stratum of water due to the formation of gallates of iron (Ill) or other metals that shield against light rays which are effective for photosynthesis.

The present invention also concerns a method of algicidal, algistatic, herbicidal or herbistatic treatment of an aquatic bottom stratum, comprising contacting the composition with the aquatic environment to be treated, the composition being deposited on the aquatic bottom, dissolving progressively by releasing gallic acid over a few days to a few weeks preferably in an aquatic bottom stratum of water having a height of at most 30 cm, more preferably at most 20 cm, in particular at most 15 cm. Preferably, gallic acid forms a coloration in an aquatic bottom stratum of water in the form of gallates of iron (Ill) or other metals that shield against light rays.

The present invention concerns a process for manufacturing the composition having an algicidal, algistatic, herbicidal or herbistatic effect in encapsulated form, comprising the step of conditioning gallic acid in a water-degradable hard-shell capsule of a composition comprising starch or gelatin. The present invention also concerns a process of manufacturing in compacted form preferably in the form of granules or balls, comprising the steps of mixing gallic acid with the excipient(s) selected from the groups of binder product, gelling product, thickening product, swelling and disintegrating product, effervescent product and compressing the mixture with the excipient(s) to form compacted granules or balls. The process preferably comprises the additional step of adjusting the particle size of the granules, by grating the balls in a grater granulator equipped with a grid of 6 mm then screening on a grid of 2 mm.

More particularly, the polyphenol(s), phenolic acid(s) which may be chosen in addition to gallic acid are pyrogallic acid, ellagic acid, tannic acid, gallotanic acid, caffeic acid, quercetin, resveratrol, resorcinol, catechol, scopoletin and among the alkaloids gramine and hordenine.

Pyrogallic acid or pyrogallol (Structure 2) is a triphenol. It is in the form of a colorless crystalline solid. It exists naturally in galls of oaks (gall nuts), sumac, hamamelis, tea leaves, oak bark, among other plants. Salts and esters derived from this acid are called gallates.

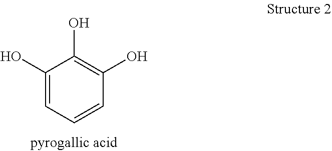

Physicochemical Properties of Pyrogallic Acid

Physical state: Solid

Density: 1.453 g/mL at 20° C.

Solubility in water: 588.00 g/L at 20° C.

Ellagic acid or 2,3,7,8-Tetrahydroxy(1)benzopyrano (5,4,3-cde)-(1)benzopyran-5,10-dione (Structure 3) is an antioxidant polyphenol present in many fruits and vegetables such as chestnuts, raspberries, strawberries, cranberries, walnuts, pecan nut, pomegranates, etc. The plants produce ellagic acid and glucose that combine to form ellagitannins which are water-soluble compounds. Ellagic acid is one of the main constituents of many tannin plants producing tannins known as ellagitannins.

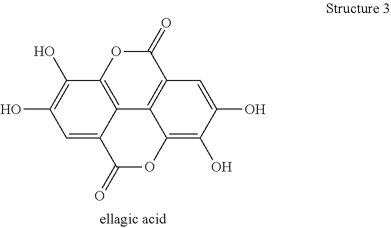 [SMILES: O=c1oc2c(O)c(O)cc3c(=O)oc4c(O)c(O)cc1c4c23]

Physicochemical Properties of Ellagic Acid:

Physical state: solid

Empirical formula: C₁₄H₆O₈

Molar mass: 302.12926±0.014 g·mol⁻¹

Solubility: <1 g·L⁻¹ at 21° C.

Tannic or gallotannic acid or beta-D-Glucose pentakis(3,4-dihydroxy-5-((3,4,5-trihydroxybenzoyl)oxy)benzoate) (structure 4) is a polyphenol of the family of tannins. It is present in gall nuts, bark and other parts of plants. It is used for the clarification of wine or beer and the denaturation of industrial alcohol. It has an astringent taste similar to gallic acid. Tannic acid is a derivative of gallic acid, more precisely a glucose polyester. There are ten units of gallic acid for one glucose. It is a yellow to light brown compound which is highly soluble in water (one gram per 0.35 mL of water). It is a weak acid with a pKₐ around 10.

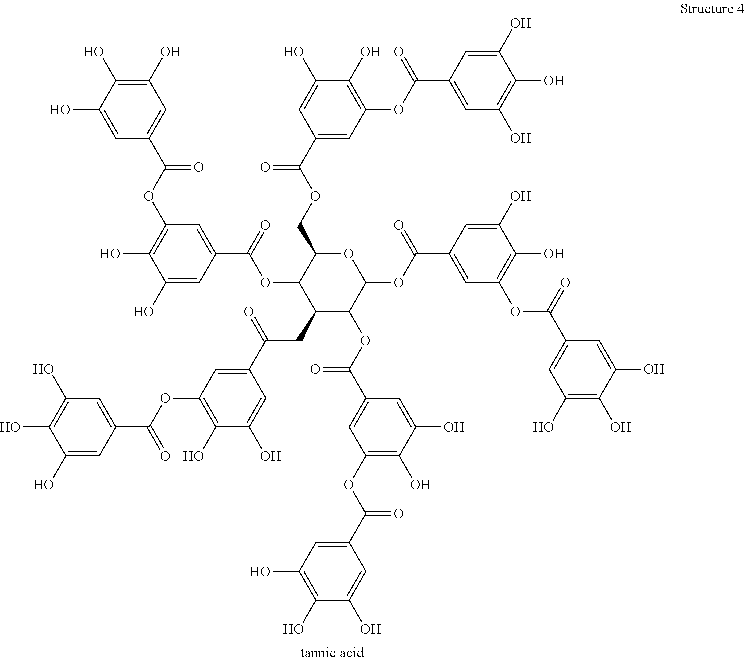 [SMILES: O=C(C[C@@H]1C(OC(=O)c2cc(O)c(O)c(OC(=O)c3cc(O)c(O)c(O)c3)c2)C(OC(=O)c2cc(O)c(O)c(OC(=O)c3cc(O)c(O)c(O)c3)c2)O[C@H](COC(=O)c2cc(O)c(O)c(OC(=O)c3cc(O)c(O)c(O)c3)c2)C1OC(=O)c1cc(O)c(O)c(OC(=O)c2cc(O)c(O)c(O)c2)c1)c1cc(O)c(O)c(OC(=O)c2cc(O)c(O)c(O)c2)c1]

Physicochemical Properties of Tannic Acid

Physical state: yellow-brown amorphous powder

Empirical formula: C₇₆H₅₂O₄₆

Solubility: Soluble in water (one gram per 0.35 mL), ethanol, acetone, methyl alcohol

Caffeic acid or (E) 3-(3,4-dihydroxyphenyl)prop-2-enoic acid (structure 5) is an organic compound naturally present in all plants, because it is a key intermediate in the biosynthesis of lignin. It is a derivative of cinnamic acid which has a structure very similar to ferulic acid and, like it, it belongs to the large families of phenylpropanoids and phenolic acids. It has no connection with caffeine, but is naturally present in small quantities in coffee in the free state and in large quantities in the esterified state.

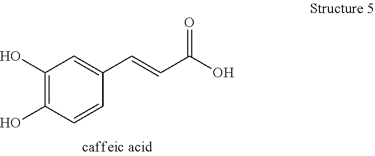 [SMILES: O=C(O)/C=C/c1ccc(O)c(O)c1]

Physicochemical Properties of Caffeic Acid

Physical state: yellow crystalline powder

Empirical formula: C₉H₈O₄

Solubility: poorly soluble in water

Quercetin or quercetol or 3′,4′,5,7-pentahydroxy-2-phenylchromen-4-one or 2-(3,4-dihydroxyphenyl)-3,5,7-trihydroxy-4H-chromen-4-one (Structure 6) is a flavonol-type flavonoid present in plants as a secondary metabolite. Quercetin is one of the most active flavonoids. Some medicinal plants owe their effectiveness to their high quercetin level. Quercetin is also known for its antioxidant properties.

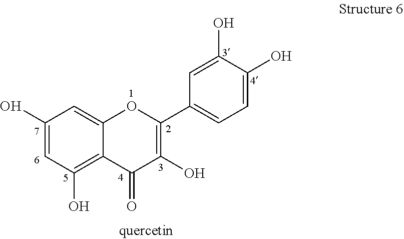 [SMILES: O=c1c(O)c(-c2ccc(O)c(O)c2)oc2cc(O)cc(O)c12]

Physicochemical Properties of Quercetin:

Physical state: yellow powder

Empirical formula: C₁₅H₁₀O₇

Solubility: water 60 mg·L⁻¹

Resveratrol or 5-[(E)-2-(4-hydroxyphenyl)-ethenyl] benzene-1,3-diol (structure 7) is a polyphenol of the stilbene class present in some fruits such as grapes, blackberries or peanuts. It is found in significant quantities in the grapes, and therefore in the wine produced therefrom.

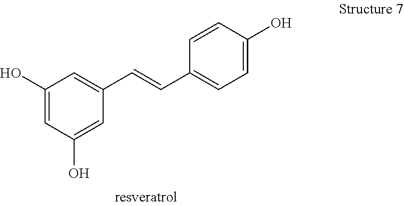 [SMILES: Oc1ccc(/C=C/c2cc(O)cc(O)c2)cc1]

Physicochemical Properties of Resveratrol:

Physical state: solid

Empirical formula: C₁₄H₁₂O₃

Solubility: water ˜0.03 mg·mL⁻¹, ethanol 50 mg·mL⁻¹, DMSO ˜16 mg·mL⁻¹.

Resorcinol or resorcin or benzene-1,3-diol (structure 8) is the meta isomer of benzenediol. It is a diphenol (C₆H₄(OH)₂) used as an antiseptic and for the preparation of some dyes: resorcinol blue, resorcinol green. The term is composed from resin and orcin.

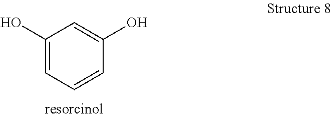

Physicochemical Properties of Resorcinol:

Physical state: white crystals

Empirical formula: C₆H₆O₂

Solubility: water 1400 g L⁻¹.

Catechol (pyrocatechol) or benzene-1,2-diol (Structure 9) is a biphenol found in some plants. It can be obtained from orthochlorophenol by the alkaline fusion reaction. It is used as an antioxidant, because it inhibits the oxidation chain reactions by capturing radicals. It prevents the spontaneous polymerization of some ethylenic compounds such as styrene.

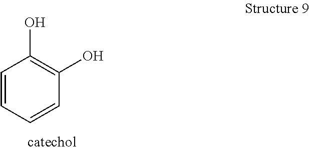

Physicochemical Properties of Catechol

Physical state: Solid

Density: 1.344 g/mL at 20° C.

Solubility in water: 435.00 g·L⁻¹ at 20° C.

Scopoletin or scopoletol or 7-hydroxy-6-methoxychromen-2-one (structure 11) is an aglycone coumarin. It is the equivalent of esculetin one of whose hydroxy substituents is replaced by a methoxy (—OCH₃). Its name comes from the fact that it is found in the roots of plants of the genus Scopolia, such as Scopolia carniolica or Scopolia japonica, but it is also found in wild chicory, passiflore, in Artemisia scoparia, Brunfelsia, Viburnum prunifolium or in Kleinhovia hospita. It is also found in some whiskeys and dandelion chicory.

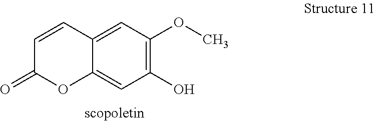

Empirical formula: C₁₀H₈O₄

Gramine (also known as donaxin) or 3-(dimethylaminomethyl)-indole (structure 10) is an indole alkaloid of formula (C₈H₆N)CH₂N(CH₃)₂ present in many plants, particularly in grasses. The latter can use it in a defensive role, the molecule being toxic for many organisms.

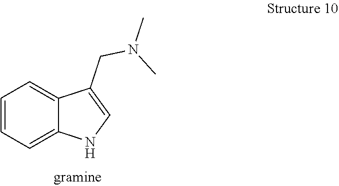

Empirical Formula: C₁₁H₁₄N₂

Hordenine or 4-[2-(dimethylamino)ethyl]phenol (structure 12) is an alkaloid of the phenylethylamine class, extracted from barley millet (barley seeds separated from malt of breweries). This is the barley Hordenum vulgare, from the grass family. Hordenine includes both an acidic functional group (phenol) and a basic functional group (amine) so it is an ampholyte. The common salts resulting from the protonation of the amine function are hordenine sulphate and hordenine hydrochloride.

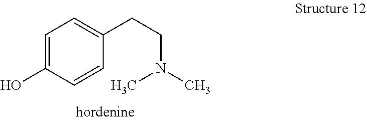

Empirical formula: C₁₀H₁₅ON

All phenolic acids, polyphenols, alkaloids previously mentioned can be used individually or in combination with gallic acid.

### DESCRIPTION OF THE FIGURES

Other particularities and features of the invention will emerge from the detailed description of some advantageous embodiments presented below, by way of illustration, with reference to the appended figures. These show:

FIG. 1: is a photo of balls, granules (a) and a capsule (b) comprising 79.4% gallic acid, 13.9% guar gum and 6.7% starch.

FIG. 2: are photos showing the herbicidal effect of gallic acid compacted with guar gum and starch on Nuttall's waterweed in comparison with an untreated control Nuttall's waterweed.

FIG. 2a represents the control foot with, in the center, the main stem, its terminal bud and an axillary bud. On either side of the main stem, two secondary stems formed by the growth of two axillary buds can be seen.

FIG. 2b represents necrotic waterweed stems with deposits of gallate of iron on the surface of the plant and inside the cells.

FIG. 2c represents a detail of a control stem apex.

FIG. 2d represents the apex of the necrotic stem.

FIG. 3: shows the biocidal effect on Eurasian Watermilfoil (Myriophyllum spicatum); on the left, control individual; on the right, individual treated.

### EXAMPLES

Preparation of the Gallic Acid Composition and Preparation of the Balls or Granules

For example, for the treatment of rooted hydrophytes, the active substance comprising gallic acid is conditioned in the form of balls (average weight of 15 g) obtained by compression (slugging) of a mixture with various excipients allowing release kinetics of the active substance. The granules can be obtained by grating the balls according to a desired particle size and the capsules are obtained by encapsulating the active substance in a hydrodegradable hard-shell capsule (FIG. 1).

The immersion of the balls, granules or capsules takes place during the period of resumption of activity of the aquatic plants, in spring, during budding from rooted and perennial parts. Another application may be performed in case of incomplete water weed cutting or lifting with the effect of blocking a regrowth from the buds remaining on the stems below the cutting height of about 30 cm and from the remaining rhizomes. The treatment is effective within a bottom stratum created by one of the excipients. This protocol allows an early attack of the hydrophyte with a treatment restricted to a volume of bottom water limited to a thickness of 10 to 20 cm whereas at the maximum of the growth, the stems can reach the surface and exceed, according to the target species, the 4 m long with many buds attached along the length of the main stem.

The choice of excipient is made among the excipients allowing the release then the more or less rapid dissolution of the active substance in the aquatic environment. The main excipients that have been tested are starch, bentonite and guar gum:

Soluble starch allows disintegration of the granule or ball with contacting the gallic acid powder with water.

Bentonite allows swelling of the entire ball at the same time as cracking to its core which increases the exchange surface between water and the active substance.

The guar gum allows a progressive swelling of the ball from the surface to the core with a formation of a hydrogel sticking the ball to the substrate.

The quantity of balls, with an average weight of 15 g, to be immersed per m² is a function of the density of the population of hydrophytes to be treated. It is necessary to achieve, for a chronic toxicity effect, a concentration of gallic acid and its gallates of at least a few mg/L over a period of 4 to 6 weeks. This contact time between the active substance and the plant corresponds to the time taken by the buds to reach a length of 20 cm. This protocol allows to take place in chronic toxicity and not in acute toxicity. An on-site prospection at the beginning of spring growth allows to choose the most appropriate formulation for the site to be treated.

The number of 15 g balls to be immersed varies from 1 to 3 per m² depending on the concentration of gallic acid relative to those of the different excipients.

In order to monitor the evolution of active substance concentrations in bottom, two different methods of analysis were used: HPLC-UV for the analysis of non-chelated gallic acid and UV-visible spectrophotometry for the analysis of gallates of iron (III). The results provided are those obtained by HPLC in the laboratory and those obtained by spectrophotometry in the laboratory and in the field.

Protocol of Analysis of Gallic Acid from Gallates of Iron.

The knowledge, on-treated site, of gallic acid concentrations is obtained by an indirect method by causing, by addition of a ferric chloride solution in a water sample of the treated site, the quick formation in few minutes of the gallates of iron (III). The respect of the ratio gallic acid/FeCl3 of 3:2 allows obtaining the maximum absorbance at 625 nm. Obtaining, from reference scale, the equations of the regression lines allows deducing, in the field, the concentration of gallic acid at the source of the formation of gallates. These regression lines are obtained as a function of the salting-out time of gallic acid and the temperature.

Results on Natural Site.

The pond of the municipality of Bousse (France) is a former sandpit of 2 hectares in North/South orientation water, of an average depth of 2.50 m with a maximum of 3.50 m; distant from the course of the Moselle of about 15 m with episodes of flood which brought in the gravelpit in addition to the conventional species of a water classified in 2nd category, three species of fish in course of colonization: the catfish, the goby and the catfish. Since 2010, the Fishing Society “La Sander” has been observing an invasion of hydrophytes and has practiced water weed cutting and grubbing in 2014 and 2015 with the known harmful consequence of an intense propagation by cutting. The treated surface is 1000 m² namely 50 m of bank (pseudo-dyke) on 20 m distance to this bank. This surface is actually a rectangular surface with 2 sides on the bank.

Four successive sectors (SA1 to SA4) were marked by laying buoys on the open water side and by stakes on the 20 m bank. Two formulations were tested namely granules (SA2, SA4) or balls (SA1, SA3) with the active substance associated with two excipients, namely guar gum or soluble starch.

The quantity of granules or balls to be used per area of 1 m² was calculated to obtain a theoretical maximum active substance concentration of 200 mg/L in a bottom stratum of water of 10 cm thick and in a short time. A control of concentrations was carried out. This control showed that the use of excipients allowed a delayed and slow salting-out of the active substance which caused the maintenance for several weeks of low concentrations. The toxicity generated is therefore a chronic toxicity and not an acute toxicity.

Result of Genic Acid Concentrations in Bousse Water Samples Taken at 30 Cm from the Bottom and at Different Time Periods (4 h, 6 h and 48 h).

TABLE 1

| Sector | 4 h | 6 h | T48 h |
|---|---|---|---|
| SA1 | <0.05 mg/L | <0.05 mg/L | <0.05 mg/L |
| SA2 | <0.05 mg/L | <0.05 mg/L | <0.05 mg/L |
| SA3 | <0.05 mg/L | <0.05 mg/L | 0.172 mg/L |
| SA4 | <0.05 mg/L | <0.05 mg/L | 0.213 mg/L |

The gallic acid concentrations released from the balls and granules, solubilized in the water of the site and not chelated are, at the bottom and during the 48 hours following the treatment, mainly below the threshold of detection by HPLC-UV which is 0.050 mg/L. This threshold is only exceeded, 48 hours after the treatment, in sector SA3 and SA4 in the samples of bottom water. These gallic acid concentrations are referred to as “residual”. Gallic acid concentrations at the surface are always below the threshold of detection by HPLC-UV.

Result of Total Gallic Acid Concentrations in Bousse Water Samples Taken at 30 cm from the Bottom and at Different Time Periods (4 h and 48 h).

The term “total gallic acid” refers to the sum of residual gallic acid concentrations with those of chelate gallic acid (gallates of iron).

TABLE 2

| | | |
|---|---|---|
| Sector SA4 - Granules | 4 h | 48 h |

| | | | | |
|---|---|---|---|---|
| Gallates | 2.837 | mg/L | 4.605 | mg/L |
| Residual Gallic Acid | <0.050 | mg/L | 0.213 | mg/L |
| Total Gallic Acid | 2.837 | mg/L | 4.818 | mg/ |

The release of the active substance from balls (SA3) or granules (SA4) is therefore slow and allows exerting an algicidal, algistatic, herbicidal or herbistatic action on chronic exposure over several weeks with an impact limited to the bottom stratum of water. These low but effective concentrations allow limiting the algicidal, algistatic, herbicidal or herbistatic action to the target organisms (hydrophytes) and respecting non-target organisms.

Evaluation of the Algicidal, Algistatic, Herbicidal or Herbistatic Effect of the Treatment on Hydrophytes.

The aim of the treatment being a slowing down of the growth (preventive effect) or a destruction of hydrophytes during the spring period of recovery of growth (curative effect).

The evaluation of the effects of the active substance on the hydrophytes as a function of the treated sectors and the nature of the excipient used successively concerns:

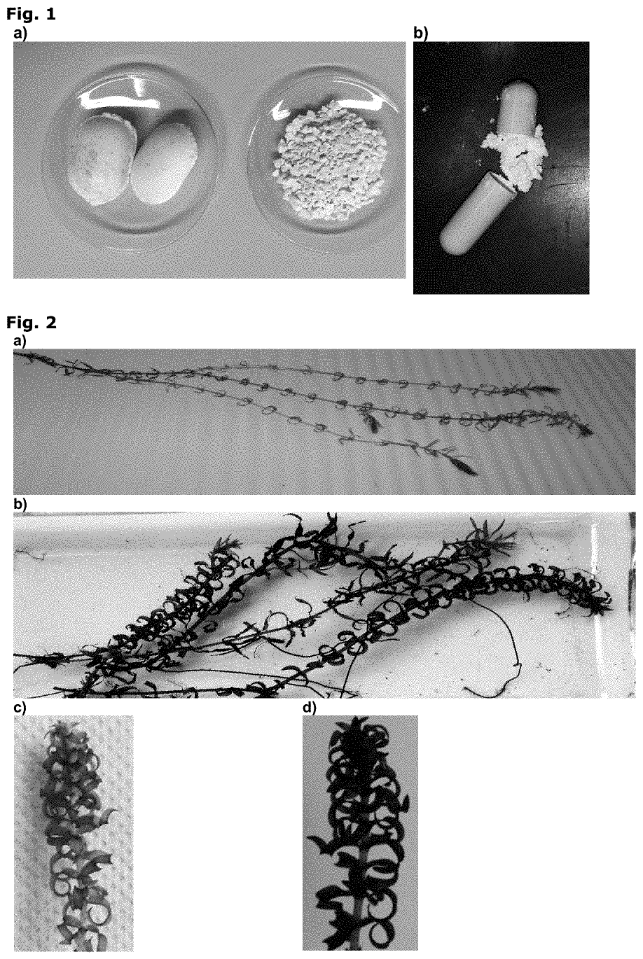

The effect of the active substance on the stems, the terminal and axillary buds of waterweed (Elodea Nuttallii) at 48 h and at 3 weeks depending on the excipient used (FIG. 2).

The effect of the active substance on the other hydrophytes since the waterweed represents 91% of the stand of hydrophytes, Eurasian watermilfoil (Myriophyllum spicatum) 5% and Ceratophyll (Ceratophyllum cornutum=C. demersum) 4%.

The theoretical quantity of active substance that can be released from balls or granules is the same in all cases, the excipient used does not have an algicidal, algistatic, herbicidal or herbistatic effect and is of food grade.

Evaluation of the Algicidal, Algistatic, Herbicidal or Herbistatic Effect on the Stems and their Terminal Bud at 48 h and at 3 Weeks According to the Formulation Used.

A control sector and each treated sector are subject to sampling from a batch of hydrophytes with a 4 m telescopic rake. After gentle washing in the water of the site, 21 to 25 feet of waterweed with their root, the main stem, the secondary stems and the axillary buds are randomly taken and are subject to measurements and observations concerning the existence, location and importance of necrosis.

Results after 48 Hours of Treatment:

TABLE 3
Site: Bousse
Duration of treatment: 48 h

| | | | | | | | | Terminal | |
|---|---|---|---|---|---|---|---|---|---|
| | | Main stem with terminal bud | | | | | | bud | |
| | | | | Necrosis | | | | Necrosis | |
| Station | Excipient | N1 | L1 | N1 | Ln1 | % n1/N1 | % necrotic L | N2 | % n2/N1 |
| StREF | 0 | 25 | 695 | 11 | 147 | 44.00% | 21.15% | 0 | 0.00% |
| SA1 | Boul | 25 | 686 | 14 | 104 | 56.00% | 15.16% | 4 | 16.00% |
| | Exc1 | | | | | | | | |
| SA2 | GR Exc2 | 25 | 553 | 8 | 36 | 32.00% | 6.51% | 2 | 8.00% |
| SA3 | Boul | 25 | 625 | 13 | 178 | 52.00% | 28.48% | 6 | 24.00% |
| | Exc2 | | | | | | | | |
| SA4 | GR Exc1 | 25 | 580 | 20 | 391 | 80.00% | 67.41% | 19 | 76.00% |

Legend of abbreviations:
Ni: Number of feet studied.
L1: Total length of stems of N1 feet including their terminal bud (in cm).
n1: number of feet with necrosis.
Ln1: Total length of stem with necrosis (in cm).
% n1/N1: % of feet with necrosis among the N1 number of feet studied.
% necrotic L: % necrotic stem length (Ln1/L1) × 100.
n2: Number of feet with necrotic terminal bud.
% n2/Ni: % of feet with one necrotic terminal bud among all the terminal buds. These are as numerous as the stems studied.

Result after 3 Weeks of Treatment:

TABLE 4
Site: Bousse
Duration of treatment: 3 weeks

| | | Main stem with terminal bud | | | | | | Terminal bud | |
|---|---|---|---|---|---|---|---|---|---|
| | | | | Necrosis | | | | Necrosis | |
| Station | Excipient | N1 | L1 | N1 | Ln1 | % n1/N1 | % necrotic L | N2 | % n2/N1 |
| StREF | 0 | 25 | 700 | 0 | 0 | 0.00% | 0.00% | 0 | 0.00% |
| SA1 | Boul | 21 | 460 | 21 | 406 | 100.00% | 88.26% | 21 | 100.00% |
| | Exc1 | | | | | | | | |
| SA2 | GR Exc2 | 24 | 735 | 24 | 649 | 100.00% | 88.30% | 24 | 100.00% |
| SA3 | Boul | 21 | 530 | 21 | 462 | 100.00% | 87.17% | 21 | 100.00% |
| | Exc2 | | | | | | | | |
| SA4 | GR Exc1 | 23 | 540 | 23 | 424 | 100.00% | 78.52% | 23 | 100.00% |

The effectiveness of the treatment for % of feet having a necrosis relative to the number of feet studied at 3 weeks is identical and of 100% regardless of the formulation used. No necrosis was observed in individuals of the control group.

The effectiveness of the treatment concerning the % of necrosis of the terminal bud at 3 weeks is identical and 100% regardless of the formulation used.

The effectiveness of the 100% treatment, identical to 3 weeks, on the number of necrotic feet and on that of the necrotic terminal buds indicates that after this time of presence the necrosis affects the entire plant.

Partial Conclusions of the Algicidal, Algistatic, Herbicidal or Herbistatic Effect of the Treatment on the Stems and their Terminal Bud at 48 h and at 3 Weeks.

After 48 hours of treatment the use of the composition SA4 is most effective with 80% of the stems having a necrosis affecting 67.4% of their length. After 3 weeks the number of feet with necrosis is 100% regardless of the formulation but the % of necrotic stem length is significantly lower with the composition SA4 than for the other formulations (78.5% against an average of 87.9% for the groups SA1 to SA3). The explanation proposed is a too rapid dilution of the active substance delivered in the form of granules containing the excipient 1. Ball compression with the same excipient (starch) allows a slow dissolution and it is the same with the balls or granules associated with the excipient 2 (starch and guar gum). These three formulations provide the same results after 3 weeks with 100% of the stems having a necrosis on an average of 87.9% of their length.

At 48 h and in the presence of the composition SA4, the terminal bud affected concerns 76% of the feet; the other formulations have a significantly lower efficiency with an average of 16% of necrotic terminal buds. After 3 weeks, necrosis of the terminal bud affects 100% of the feet regardless of the formulation.

In order to refine the choice of the best formulation, the algicidal, algistatic, herbicidal or herbistatic effect on the axillary buds, which are the source of the multiplication of secondary branches carried by the main stem of waterweed, should be studied in parallel.

Evaluation of the Algicidal, Algistatic, Herbicidal or Herbistatic Effect on the Other Hydrophytes: Eurasian Watermilfoil (Myriophyllum spicatum) and Ceratophyll (Ceratophyllum cornutum).

Two other hydrophytes are associated with Nuttall's Waterweed, Eurasian watermilfoil (Myriophyllum spicatum), and Ceratophyllum (Ceratophyllum cornutum), which represent respectively 5% and 4%, of the stand.

Given the low presence of these two species relative to the Waterweed dominance, the evaluation of the effectiveness of the treatment was done by grouping the data of all individuals harvested on all the treated sectors and regardless of the formulation used.

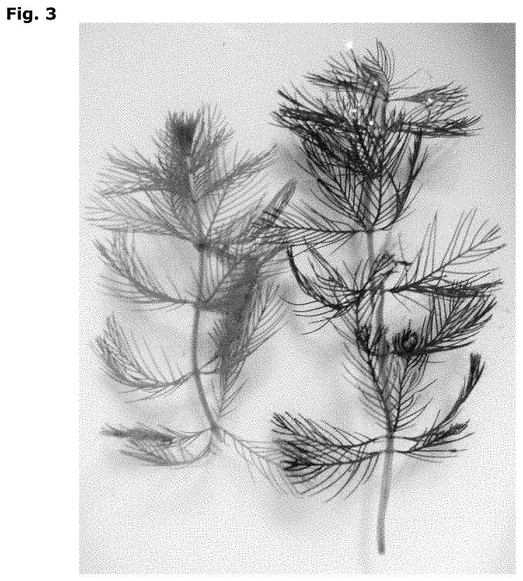

The Watermilfoil stems can reach 1.50 m in length with an average of 0.87 m for the studied stems. The average biocidal effectiveness is 97.3% for the stems including the terminal bud. The average number of axillary bud is 1 per stem with 100% biocidal effectiveness. The biocidal effect on the Eurasian Watermilfoil (Myriophyllum spicatum) is shown in FIG. 3; on the left, control individual; on the right, treated individual.

Hornwort stems can reach 1.10 m in length with an average of 0.69 m for the studied stems. The algicidal, algistatic, herbicidal or herbistatic effectiveness is on average 52.8% for the stems including the terminal bud. The average number of axillary buds is 2.2 per stem with 47.3% algicidal, algistatic, herbicidal or herbistatic effectiveness.

The treatment is therefore active on the two species of hydrophytes associated with Waterweed with a higher effectiveness for Watermilfoil compared to Hornwort.

General Conclusion on the Evaluation of Algicidal, Algistatic, Herbicidal or Herbistatic Effect of the Treatment.

Regardless of the formulation used, the algicidal, algistatic, herbicidal or herbistatic effectiveness of the treatment can be evaluated after three weeks of effect.

Concerning the feet with their terminal bud, the consideration of the criteria of % of feet and % of necrotic terminal buds does not allow promoting a formulation over the others because the algicidal, algistatic, herbicide or herbistatic effectiveness is identical and 100%. The consideration of the criterion of the necrotic stem length allows distinguishing the formulation in granules containing the excipient of the composition SA4 from the other three because of its lower effectiveness (78.5% against an average of 87.9%).

Concerning axillary buds, which play a major role in biomass increment capacity and propagation by cutting, the consideration of the criterion of % of necrotic buds allows distinguishing the granules (composition SA2 and SA4) from the balls (composition SA1 and SA3) because of their lower effectiveness, namely on average 31.8% against 42.3%.

Considering in last criterion the % of feet bearing necrotic axillary buds the treatment with balls containing the excipient of the composition SA1 differs from that with balls containing the excipient of the composition SA3 because of its reduced effectiveness namely 33.3% against 42.86%.

Independently of the formulation used, the treatment is of an overall efficiency (stem and buds) of 100% on Watermilfoil and of an overall efficiency (stem and buds) of 50% on the Hornwort.

1. A use of a composition comprising gallic acid as an active ingredient wherein gallic acid is associated with one or more excipients selected from the following groups:
(1) a binder product selected from the group consisting of wheat flour, soluble starch or rosin,
(2) a gelling product selected from the group consisting of agar-agar, alginates, carrageenan, pectin, chitosan, cellulose or gelatin,
(3) a thickening product selected from the group consisting of gum arabic, guar gum or xanthan gum,
(4) a swelling and disintegrating product selected from the group consisting of bentonite or smectite, and
(5) an effervescent product selected from the group consisting of bicarbonates,
wherein gallic acid is in encapsulated or compacted form, and wherein the content of excipients is comprised between 50% and 5% of the total weight of the composition, for an algicidal or algistatic, treatment of akinetes at an aquatic bottom stratum of water by the controlled release of the active ingredient,
wherein the use comprises contacting the composition with the aquatic environment to be treated, the composition being deposited on the aquatic bottom, being gradually dissolved by releasing gallic acid for a few days to a few weeks preferably in an aquatic bottom stratum of water having a height of at most 30 cm, more preferably at most 20 cm, in particular at most 15 cm.

2. The use of a composition according to claim 1 wherein gallic acid is associated with at least one phenolic acid or polyphenol selected from the group consisting of pyrogallic acid, ellagic acid, tannic acid, gallotanic acid, caffeic acid, quercetin, resveratrol, resorcinol, catechol, scopoletin or at least one alkaloid selected from gramine and hordenine.

3. The use of the composition according to claim 1, wherein the density of the composition is greater than 1 kg/dm3, preferably greater than 1.05 kg/dm3 and more preferably greater than 1.1 kg/dm3.

4. The use of the composition according to claim 3, wherein the excipients are preferably selected from two excipients belonging to two distinct groups, and preferably the excipients are chosen from the groups (1) and (3).

5. The use of the composition according to claim 1, being in the form of granules, balls or capsules of an average mass between 1 and 100 g, preferably between 2 and 50 g, more preferably between 10 and 30 g for the balls and between 2 and 5 g for the granules and the capsules.

6. The use of the composition according to claim 1, wherein gallic acid content is comprised between 50% and 95% of the total weight of the composition, preferably between 70% and 90% of the total weight of the composition, and more preferably between 75% and 85% of the total weight of the composition.

7. The use of the composition according to claim 1, wherein the content of excipients is comprised between 30% and 10% of the total weight of the composition, and more preferably between 25% and 15% of the total weight of the composition.

8. The use of the composition according to claim 1, wherein the concentration of total gallic acid in the aquatic bottom stratum of water is controlled to values ranging from 0.05 mg/L to 500 mg/L, in particular to chronic toxic concentrations, such as concentrations ranging from 0.1 mg/L to 10 mg/L, preferably ranging from 0.2 mg/L to 5 mg/L, or in particular to acute toxic concentrations, such as concentrations ranging from 60 mg/L to 500 mg/L.

9. The use of the composition according to claim 8, of which at least one part of the algicidal or algistatic effect is obtained by coloration in an aquatic bottom stratum of water due to the formation of gallates of iron or other metals that shield against light rays.

10. A composition having an algicidal or algistatic effect on akinetes at an aquatic bottom stratum of water, the composition comprising, as an active ingredient, gallic acid associated with one or more excipients selected from the following groups:
(1) a binder product selected from the group consisting of wheat flour, soluble starch or rosin,
(2) a gelling product selected from the group consisting of agar-agar, carrageenan, pectin, chitosan, cellulose or gelatin,
(3) a thickening product selected from the group consisting of gum arabic, guar gum or xanthan gum,
(4) a swelling product selected from the group consisting of bentonite or smectite, and
(5) an effervescent product selected from the group consisting of bicarbonates,
wherein gallic acid is in encapsulated or compacted form, wherein the content of excipients is comprised between 50% and 5% of the total weight of the composition and whose density is greater than 1 kg/dm3, preferably greater than 1.05 kg/dm3 and more preferably greater than 1.1 kg/dm3.

11. The composition according to claim 10, wherein gallic acid is associated with at least one phenolic acid or polyphenol selected from the group consisting of pyrogallic acid, ellagic acid, tannic acid, gallotanic acid, caffeic acid, quercetin, resveratrol, resorcinol, catechol, scopoletine or at least one alkaloid selected from gramine and hordenine.

12. The composition according to claim 11, wherein the excipients are chosen from two excipients belonging to two distinct groups, and preferably the excipients are selected from the groups (1) and (3).

13. The composition according to claim 10, being in the form of granules, balls or capsules of an average mass between 1 and 100 g, preferably between 2 and 50 g, more preferably between 5 and 30 g for the balls and between 2 and 5 g for the granules and the capsules.

14. The composition according to claim 10, wherein the content of gallic acid associated with at least one phenolic acid or polyphenol or alkaloid is comprised between 50% and 95% of the total weight of the composition, preferably between 70% and 90% of the total weight of the composition, and more preferably between 75% and 85% of the total weight of the composition.

15. The composition according to claim 10, wherein the content of excipient(s) is comprised between 30% and 10% of the total weight of the composition, and more preferably between 25% and 15% of the total weight of the composition.

16. A process for manufacturing a composition having an algicidal or algistatic effect on akinetes according to claim 10 in encapsulated form, comprising the step of conditioning gallic acid in a water-degradable hard-shell capsule selected from gelatin or starch.

17. The process for manufacturing a composition having an algicidal or algistatic effect on akinetes in compacted form according to claim 10, preferably in the form of granules or balls, comprising the steps of:
mixing the at least one phenolic acid or polyphenol or alkaloid with one or more excipients selected from the following groups:
(1) a binder product selected from the group consisting of wheat flour, soluble starch, or rosin,
(2) a gelling product selected from the group consisting of agar-agar, alginates, carrageenan, pectin, chitosan, cellulose or gelatin,
(3) a thickening product selected from the group consisting of gum arabic, guar gum or xanthan gum,
(4) a swelling and disintegrating product selected from the group consisting of bentonite or smectite, and
(5) an effervescent product selected from the group consisting of bicarbonates, and
compressing the mixture with the excipients(s) to form compacted granules or balls.

18. The process according to claim 17 comprising the additional step of adjusting the particle size of the granules by grating the balls in a grater granulator then screening.

19. A method of algicidal or algistatic treatment of akinetes of an aquatic bottom stratum comprising contacting the composition according to claim 10 with the aquatic environment to be treated, the composition being deposited on the aquatic bottom, being gradually dissolved by releasing gallic acid for a few days to a few weeks preferably in an aquatic bottom stratum of water having a height of at most 30 cm, more preferably at most 20 cm, in particular at most 15 cm.

20. The method of algicidal or algistatic treatment according to claim 19, wherein gallic acid forms a coloration in an aquatic bottom stratum of water in the form of gallates of iron or other metals that shield against light rays.
